(19) United States
(12) Patent Application Publication
(10) Pub. No.: US 2015/0058036 A1
(43) Pub. Date: Feb. 26, 2015

(54) PROTECTING PAYMENT INTERESTS OF MEDICARE

(71) Applicant: Flagship Services Group, LLC, Englewood, CO (US)

(72) Inventor: Kendell L. Gracey, Parker, CO (US)

(21) Appl. No.: 14/468,061

(22) Filed: Aug. 25, 2014

Related U.S. Application Data
(60) Provisional application No. 61/869,184, filed on Aug. 23, 2013.

(51) Int. Cl. G06F 19/00

(52) U.S. Cl. CPC G06F 19/328
USPC 705/2

(57) ABSTRACT

An apparatus, system, and method are disclosed for protecting payment interests of Medicare. A task module identifies one or more tasks associated with protecting a Medicare payment interest for a claim involving a Medicare beneficiary. An order module assigns a priority value to each of the one or more tasks and determines a completion order for the one or more tasks base on the priority values. An adjustment module determines a new completion order for one or more remaining tasks in response to receiving a status update during completion of the one or more tasks.

### CROSS-REFERENCES TO RELATED APPLICATIONS

This application claims the benefit of U.S. Provisional Patent Application No. 61/869,184 entitled “METHODS AND SYSTEMS FOR PROTECTING PAYMENT INTEREST OF MEDICARE” and filed on Aug. 23, 2013, for Kendell L. Gracey, which is incorporated herein by reference.

### FIELD

The present disclosure relates to Medicare payments, and more particularly, the disclosure relates to methods and systems for protecting existing and future payment interests of Medicare.

### BACKGROUND

In the United States, the national social insurance program known as Medicare requires that its interests are protected, including its past, current, and future interests. U.S. law considers Medicare a secondary payer and requires that its interest are protected in situations where a Medicare beneficiary sustains some type of personal injury and then receives a settlement, judgment, award, payment or other monetary compensation from a primary payer—such as, for example, a general liability insurance carrier, no-fault insurance carrier, workers' compensation insurance carrier, a self-insured entity, or a public entity.

Medicare considers its interests protected when (1) a primary payer properly reimburses Medicare for past and/or current conditional payments that Medicare paid for medical treatment of a Medicare beneficiary, or when (2) a primary payer sets funds aside to pay for future medical treatment that Medicare would likely or otherwise pay on behalf of a Medicare beneficiary. Failure to properly protect Medicare's interests creates significant risks, liabilities, and penalties for the primary payers, i.e., general liability carriers, no-fault carriers, workers' compensation carriers, as well as Non-Group Health Plan (NGHP) insurance carriers, personal injury attorneys, and the Medicare beneficiary. Such risks, liabilities, and penalties may include, for example, (1) having the primary payer pay double damages plus interest, (2) having the Medicare beneficiary lose his/her Medicare benefits, (3) holding the personal injury attorney personally liable for reimbursing Medicare, and/or (4) having the matter referred to the Department of Justice.

The primary payer is in constant fear of these liabilities while trying to comply with a complex and time consuming process for reimbursing Medicare. To complicate the process, Medicare may issue a statement/demand for reimbursement of payments, which often do not reflect correct or related costs, at any time during the compliance process. Yet, Medicare's normal process does not provide a primary payer or any other party with a final statement/demand of amounts owed to Medicare until after the primary payer closes the file or settles with the Medicare beneficiary. Moreover, the final statement/demand is often higher than Medicare's initial statement/demand—which often delays or prevents settlement. Accordingly, primary payers are often caught off guard despite conservative business practices.

In order to protect Medicare's future payment interests, primary payers generally create a Medicare Set-Aside (“MSA”) and submit the MSA to a division of Medicare, i.e. the Centers for Medicare and Medicaid Services or its contractors. Medicare does provide MSA guidelines/process steps for workers' compensation claims that a primary payer may elect to follow, but no such guidelines or regulations currently exist for general liability claims. If elected, then the primary payer is bound by all the terms and conditions of the MSA process. Otherwise, the law does not currently require the creation of MSAs nor does the law require the submissions of MSAs to Medicare for approval. Regardless, however, the primary payers may have to determine the need for future medical care and treatment of a Medicare beneficiary to ensure that Medicare's future payment interests are protected. Yet, primary payers have no efficient way of compiling and evaluating the vast amounts of claim data in relation to complex Medicare requirements. The process of compiling and evaluating MSAs is virtually unachievable for most primary payers in that the process is extremely time consuming, inefficient, and costly.

### SUMMARY

An apparatus for protecting payment interests of Medicare is disclosed. A system and method also perform the functions of the apparatus. In one embodiment, the apparatus includes a task module that identifies one or more tasks associated with protecting a Medicare payment interest for a claim involving a Medicare beneficiary. In certain embodiments, the one or more tasks include a decision tree associated with the Medicare payment interest being protected. In various embodiments, the apparatus includes an order module that assigns a priority value to each of the one or more tasks and determines a completion order for the one or more tasks based on the priority values. In certain embodiments, the priority value indicates a priority of completing a task relative to one or more different tasks.

In some embodiments, the apparatus includes an adjustment module that determines a new completion order for one or more remaining tasks in response to receiving a status update during completion of the one or more tasks. In certain embodiments, new priority values are assigned to the one or more remaining tasks based on the status update. In one embodiment, the apparatus includes a task assignment module that assigns the one or more tasks to one or more task handlers based on the completion order. In some embodiments, the task handler of the one or more task handlers includes a Medicare processing specialist who is specialized to perform a particular task of the one or more tasks.

In one embodiment, the apparatus further includes a data module that receives Medicare information associated with the Medicare beneficiary. In some embodiments, the one or more tasks for protecting the Medicare payment interest are based on data extracted from the Medicare information. In certain embodiments, the status update comprises receiving new Medicare information associated with the Medicare beneficiary. In some embodiments, the new Medicare information comprises one or more of Medicare claim information, Medicare regulation information, and Medicare beneficiary information.

In a further embodiment, one or more remaining tasks are skipped in response to the new Medicare information. In one embodiment, a completion deadline of a task of the one or more tasks is accelerated in response to the new Medicare information. In various embodiments, the order module assigns a priority value to each task of the one or more tasks based on a claim status of a Medicare claim involving the Medicare beneficiary. In some embodiments, the claim status indicates a current processing state for the Medicare claim. In a further embodiment, the order module assigns a priority value to each task of the one or more tasks based on a compliance status for a claim involving the Medicare beneficiary. In some embodiments, the compliance status indicates a compliance risk associated with a Medicare claim involving the Medicare beneficiary.

In one embodiment, the order module assigns a priority value to each task of the one or more tasks based on a financial status for a claim involving the Medicare beneficiary. In certain embodiments, the financial status indicates a financial risk associated with a Medicare claim involving the Medicare beneficiary. In some embodiments, the order module assigns a priority value to each task of the one or more tasks based on one or more of task dependency, task timing, and task duration. In a further embodiment, the Medicare interest being protected comprises one of a past interest, a present interest, and/or a future interest.

A method is disclosed that, in one embodiment, includes identifying one or more tasks associated with protecting a Medicare payment interest for a claim involving a Medicare beneficiary. In certain embodiments, the one or more tasks comprise a decision tree associated with the Medicare payment interest being protected. In a further embodiment, the method includes assigning a priority value to each of the one or more tasks and determining a completion order for the one or more tasks based on the priority values. In one embodiment, a priority value indicates a priority of completing a task relative to one or more different tasks.

In certain embodiments, the method includes determining a new completion order for one or more remaining tasks in response to receiving a status update during completion of the one or more tasks. In a further embodiment, new priority values are assigned to the one or more remaining tasks based on the status update. In one embodiment, the method includes assigning the one or more tasks to one or more task handlers based on the completion order. In some embodiments, a task handler of the one or more task handlers comprises a Medicare processing specialist who is specialized to perform a particular task of the one or more tasks. In certain embodiments, the method includes receiving Medicare information associated with the Medicare beneficiary. In one embodiment, the one or more tasks for protecting the Medicare payment interest are based on data extracted from the Medicare information.

In various embodiments, the status update comprises receiving new Medicare information associated with the Medicare beneficiary. In certain embodiments, the new Medicare information comprises one or more of Medicare claim information, Medicare regulation information, and Medicare beneficiary information. In some embodiments, one or more remaining tasks are skipped in response to the new Medicare information. In a further embodiment, a completion deadline of a task of the one or more tasks is accelerated in response to the new Medicare information. In certain embodiments, the Medicare interest being protected comprises one of a past interest, a present interest, and/or a future interest.

A computer program product is disclosed that includes a computer readable storage medium having program code embodied therein. The program code, in certain embodiments, is readable/executable by a processor for identifying one or more tasks associated with protecting a Medicare payment interest for a claim involving a Medicare beneficiary. In certain embodiments, the one or more tasks comprise a decision tree associated with the Medicare payment interest being protected. The program code, in one embodiment, is readable/executable by a processor for assigning a priority value to each of the one or more tasks and determining a completion order for the one or more tasks based on the priority values. In one embodiment, a priority value indicates a priority of completing a task relative to one or more different tasks. In a further embodiment, the program code is readable/executable by a processor for determining a new completion order for one or more remaining tasks in response to receiving a status update during completion of the one or more tasks. In a further embodiment, new priority values are assigned to the one or more remaining tasks based on the status update.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for protecting payment interests of Medicare;

FIG. 2 is a schematic block diagram illustrating one embodiment of a module for protecting payment interests of Medicare;

FIG. 3 is a schematic block diagram illustrating one embodiment of another module for protecting payment interests of Medicare;

FIG. 4 is an embodiment of an interface for protecting payment interests of Medicare;

FIG. 5 is an embodiment of a decision flow chart for protecting payment interests of Medicare;

FIG. 6 is a schematic flow chart diagram illustrating one embodiment of a method for protecting payment interests of Medicare; and

FIG. 7 is a schematic flow chart diagram illustrating one embodiment of a method for protecting payment interests of Medicare.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

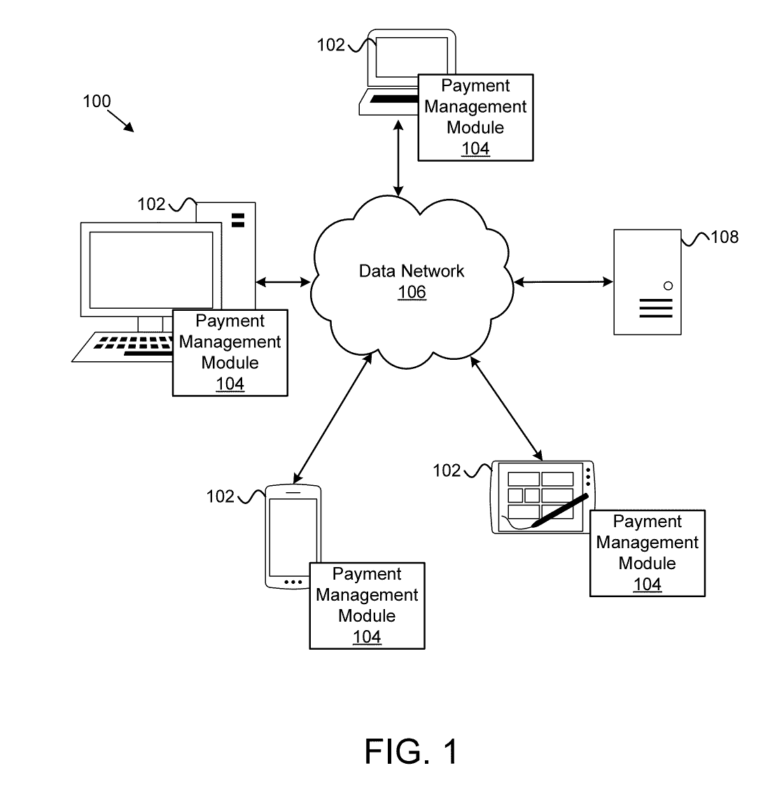

FIG. 1 depicts one embodiment of a system 100 for protecting Medicare's payment interests. In one embodiment, the system 100 includes information handling devices 102, payment management modules 104, data networks 106, and servers 108, which are described below in more detail. While a specific number of elements 102-108 of the system 100 are depicted in FIG. 1, any number of elements 102-108 may be included in the system 100 for protecting Medicare's payment interests.

In one embodiment, the information handling devices 102 include electronic computing devices, such as desktop computers, laptop computers, tablet computers, smart televisions, smart phones, servers, and/or the like. In one embodiment, the payment management module 104 is configured to identify one or more tasks associated with protecting a Medicare payment interest for a claim involving a Medicare beneficiary, assign a priority value to each task and determine a completion order for the tasks based on the priority values, and adjust the completion order based on a status update received during completion of the tasks. In certain embodiments, at least a portion of the payment management module 104 is located on an information handling device 102 and/or a server 108.

The data network 106, in one embodiment, comprises a digital communication network that transmits digital communications. The data network 106 may include a wireless network, such as a wireless cellular network, a local wireless network, such as a Wi-Fi network, a Bluetooth® network, a near-field communication (NFC) network, an ad hoc network, and/or the like. The data network 106 may include a wide area network (WAN), a storage area network (SAN), a local area network (LAN), an optical fiber network, the Internet, an internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, random access memory (RAM), or the like.

In one embodiment, the system 100 includes a server 108. The server 108 may be embodied as a desktop computer, a laptop computer, a mainframe, a cloud server, a virtual machine, or the like. In some embodiments, the information handling devices 102 are communicatively coupled to the server 108 through the data network 106. The server 108 may include data accessible by an information handling device 102 through the data network 106, such as Medicare related documents, Medicare beneficiary data, Medicare claim data, or the like.

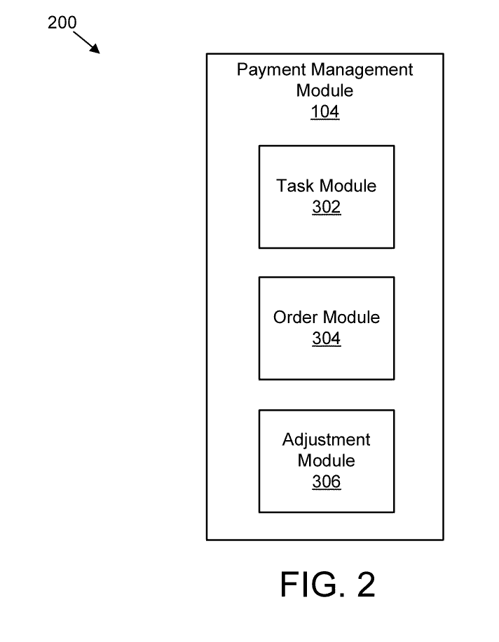

FIG. 2 depicts one embodiment of a module 200 for protecting Medicare's payment interests. In one embodiment, the module 200 includes an embodiment of a payment management module 104. The payment management module 104, in certain embodiments, includes a task module 202, an order module 204, and an adjustment module 206, which are described in more detail below.

In one embodiment, the task module 202 identifies one or more tasks associated with protecting a Medicare payment interest for a claim involving a Medicare beneficiary. As used herein, Medicare is a national social insurance program administered through the Centers of Medicare & Medicaid Services (CMS) under the Department of Health & Human Services (HHS). CMS/HHS/Medicare may have various contractors that help administer various programs under the Medicare title. A claim may involve a Medicare beneficiary if the claim is related to the Medicare beneficiary and/or another interested parties, including insurance carriers, government agencies, attorneys, primary payers, and/or the like.

A Medicare payment interest may refer to Medicare's past, present, and/or future payment interests. Thus, Medicare's payment interests may be protected when Medicare is properly reimbursed for past payments and when funds are set aside to pay for future expenses covered by Medicare. In order to determine whether Medicare's payment interests are properly protected, one or more tasks related to a Medicare claim involving a Medicare beneficiary may be determined by the task module 202, for either past, present, or future interests of Medicare, which are performed to ensure compliance with Medicare regulations, policies, rules, procedures, laws, and/or the like.

The one or more tasks, in certain embodiments, include tasks related to the Medicare beneficiary, a Medicare claim, or the like. For example, a task may include sending information packets, contacting Medicare, contacting a Medicare contractor, reviewing documents, and/or the like. In certain embodiments, the one or more tasks comprise a decision tree associated with the Medicare payment interest being protected. For example, the tasks related to protecting a past Medicare payment interest, i.e., a conditional payment made by Medicare, may be determined by the task module 202 and arranged in such a way that a user can follow a path through the tree to reach a desired result, e.g., reimbursing Medicare for the conditional payment. The path through the decision tree may touch on various tasks that must be completed before moving on to the next task and ultimately completing the tasks that protect Medicare's interests.

In certain embodiments, the task module 202 divides a task into one or more subtasks such that the completion of the subtasks completes a task. In some embodiments, the task module 202 divides subtasks into one or more second-level sub tasks, and so on. Thus, the task module 202 may divide a task into different levels of subtasks, which may comprise tasks that are at a lower level of detail and may allow the progress of tasks to be tracked at a lower level. The task module 202 associates a subtask with a parent task and tracks the progress of a parent task by tracking the progress of its one or more subtasks.

In one embodiment, the order module 204 assigns a priority value to each of the one or more tasks. In certain embodiments, a priority value indicates a priority of completing a task relative to one or more different tasks. For example, the order module 204 may assign a higher priority value to a task that needs to be completed before a different task can begin. In such an example, the task with a lower priority value may be dependent on the completion of the higher-level priority task such that the lower-level priority task cannot begin until the higher-level priority task is completed. In certain embodiments, the priority value includes an indicator, such as a number within a range from one to ten, that the order module 204 uses to determine a completion order for the tasks, as described in more detail below. For example, a task having a priority value of ten may be ranked higher than a task with a priority value of one, indicating that the higher-ranked task is to be completed before the lower ranked task.

In certain embodiments, the order module 204 assigns a priority value to a task based on a claim status of a Medicare claim involving the Medicare beneficiary. In certain embodiments, as used herein, the claim status for the Medicare claim indicates a current processing state for the Medicare claim. Thus, in certain embodiments, the order module 204 assigns higher priority values to tasks related to the claim status, such as the processing of the claim, sending documentation, making phone calls, sending emails, or the like, that need to be completed before lower-priority tasks to ensure that the claim involving the Medicare beneficiary is correctly processed.

In a further embodiment, the order module 204 assigns a priority value to a task based on a compliance status. As used herein, the compliance status indicates a compliance risk associated with a Medicare claim involving the Medicare beneficiary, and/or other parties, including, but not limited to, insurance carriers, primary payers, attorneys, or the like. Thus, in some embodiments, the order module 204 assigns higher priority values to tasks that need to be completed to ensure that the claim involving the Medicare beneficiary, insurance carriers, primary payers, attorneys, and/or the like, is in compliance with Medicare's laws, regulations, policies, procedures, or the like as it is related to protecting Medicare's payment interests.

In one embodiment, the order module 204 assigns a priority value to a task based on a financial status for the claim involving the Medicare beneficiary. As used herein the financial status indicating a financial risk associated with a Medicare claim involving the Medicare beneficiary. The financial risk may be carried by any party that pays or receives payment, such as an insurance carrier, a self-insured entity, a government entity, a Medicare beneficiary, an attorney, and/or the like. In certain embodiments, the financial risk is associated with a cost for the insurance carrier, self-insured entity, government entity, attorney, and/or the Medicare beneficiary to make a decision associated with one or more tasks. For example, if the insurance carrier, self-insured entity, government entity, attorney, and/or the Medicare beneficiary will suffer a loss of $10.00 for not taking a particular action, such as a compliance action, a claim action, or the like, then the order module 204 may assign a lower priority to the tasks associated with that action. However, if the insurance carrier, self-insured entity, government entity, attorney, and/or the Medicare beneficiary will suffer a loss of $10,000.00 for not taking a particular action, then the order module 204 may assign higher priority values to the tasks associated with that action. In certain embodiments, an insurance carrier, a self-insured entity, a government entity, an attorney, and a Medicare beneficiary are jointly and severally liable for the financial risk. Consequently, each party involved in the Medicare claim may have an obligation to Medicare, and, in particular, to protect Medicare's payment interests.

In certain embodiments, the order module 204 assigns a priority to value to tasks based on task dependency. In such an embodiment, the order module 204 assigns lower priority values to tasks that are dependent on the completion of other tasks. Thus, if task C is dependent on the completion of task B, and task B is dependent on the completion of task A, then the order module 204 may assign task A a higher priority value than both tasks B and C; and task B may be assigned a higher priority value than task C.

In a further embodiment, the order module 204 assigns a priority value to a task based on task timing. For example, if task A has a deadline within twelve hours and task B has a deadline within a week, the order module 204 may assign task A a higher priority value than task B. Similarly, the order module 204 may assign a priority value to a task based on the duration of the task. Thus, in the previous example, if task A has a deadline within twelve hours and task B has a deadline within a week, but task B only has a duration of twenty minutes to complete, the order module 204 may assign a higher priority value to task B such that other tasks dependent on the completion of task B can begin to be completed.

In one embodiment, the order module 204 determines a completion order for the one or more tasks based on the priority values. In certain embodiments, the order module 204 lists the one or more tasks in order of their priority values such that higher priority tasks are designated to be completed before lower priority tasks. In certain embodiments, the order module 204 may assign a plurality of tasks the same priority values. In such an embodiment, the tasks having the same priority values may be completed in any order, concurrently, and/or the like. In some embodiments, the completion order determined by the order module 204 comprises the decision tree for the particular Medicare payment being protected. Thus, the tasks may be ordered and presented to users associated with protecting the Medicare payment interest such that the users can determine which tasks need to be done, when the tasks need to be completed, how long each task will take, and/or the like.

In certain embodiments, the order module 204 determines different priority values for the one or more identified tasks and, consequently, a different completion order for the tasks, depending on the Medicare information received, including incident information, claim information, and/or the like. Thus, tasks may not have a predefined completion order. Instead, the completion order may be based on the status of the Medicare claim involving the Medicare beneficiary, and may be adjusted based on new information received during completion of the tasks, as described below. Therefore, the completion order for the tasks may be different for each Medicare claim, even if the Medicare claims have similar characteristics.

In some embodiments, however, the tasks may follow a predefined completion order, based on the assigned priority values, that corresponds to the Medicare information received, but the tasks may not always follow the predefined order. For example, for a Medicare claim related to a past payment interest of Medicare, the tasks may include receiving the file from the client, report the claim to Medicare, request lien information from Medicare, review the lien information, and close the file. However, if the lien information has already been received and reviewed, then those tasks may be skipped. Thus, the order module 204 may assign priorities to all the tasks that would normally be performed to determine a predefined completion order, and the adjustment module 206, described below, may adjust the completion order based on status updates, information already received, new Medicare information, or the like.

In one embodiment, the adjustment module 206 determines a new completion order for one or more remaining tasks in response to receiving a status update during completion of the one or more tasks. In some embodiments, the order module 204 assigns new priority values to the one or more remaining tasks based on the status update. In certain embodiments, as tasks are being completed, the adjustment module 206 may receive a status update associated with a Medicare beneficiary, a Medicare claim, or the like, which may necessitate a reprioritizing and reordering of the remaining tasks. For example, after receiving a status update, the adjustment module 206 may reprioritize a task, such as a task to make a phone call, send an email, and/or review, analyze or send documents, such that the task is now a high-priority task to be completed.

In certain embodiments, the status update received by the adjustment module 206 comprises receiving new Medicare information associated with the Medicare beneficiary. In certain embodiments, the new Medicare information includes Medicare claim information, Medicare regulation information, Medicare beneficiary information, Medicare financial information (e.g., Medicare reimbursement information, such as Medicare lien or conditional payment information), or the like. In one embodiment, Medicare claim information may include information associated with a beneficiary's claim status, such as receiving claim notices, claim action items, claim statements, or the like. In some embodiments, Medicare regulation information may include receiving notice of new Medicare policies, procedures, laws, regulations, or the like. Medicare beneficiary information, in a further embodiment, includes receiving new information regarding the Medicare beneficiary or the Medicare claim involving the Medicare beneficiary, such as personal information, contact information, incident information, Medicare eligibility information, insurance information, financial information, attorney information, or the like.

In some embodiments, in response to the new Medicare information, the adjustment module 206 may skip one or more remaining tasks. For example, based on the new Medicare information, one or more remaining tasks may not need to be completed in order to complete the action for to protect Medicare's payment interests. Similarly, the adjustment module 206 may accelerate the completion deadline of one or more remaining tasks in response to the new Medicare information. For example, the adjustment module 206 may move the deadline for a particular task from one week to one day in response to a new Medicare policy quickly going into effect.

In a further embodiment, the adjustment module 206 determines a new completion order for one or more remaining tasks in response to determining an error in the completion of one or more tasks. For example, if an expected output from one or more completed tasks is not met, the adjustment module 206 may determine that the task was performed incorrectly and may determine a new completion order for the remaining tasks, including determining new deadlines and performing the erroneous task again to try to get the expected output.

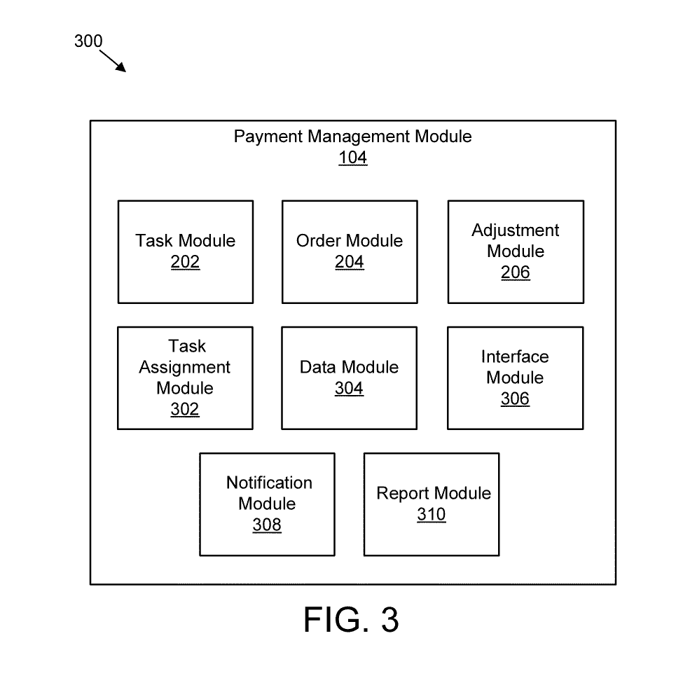

FIG. 3 depicts one embodiment of a module 300 for protecting Medicare's payment interests. In one embodiment, the module 300 includes an embodiment of a payment management module 104. The payment management module 104, in certain embodiments, includes a task module 202, an order module 204, and an adjustment module 206, which may be substantially similar to the task module 202, the order module 204, and the adjustment module 206 described above with reference to FIG. 2. In some embodiments, the payment management module 104 includes a task assignment module 302, a data module 304, an interface module 306, a notification module 308, and a report module 310, which are described in more detail below.

The task assignment module 302, in one embodiment, assigns the one or more tasks to one or more task handlers based on the completion order determined by the order module 206. The task assignment module 302 may assign a task handler one or more tasks or a task may be assigned to one or more task handlers. Thus, the task assignment module 302 may assign a task to a single task handler or a group of task handlers depending on the complexity, difficulty, or the like of the task. In one embodiment, the task handlers comprise specialists trained to complete specific tasks. For example, a Medicare claim specialist may handle one or more tasks that are directly related to handling a Medicare beneficiary's claim. Similarly, certain task handlers may be specially trained to handle tasks associated with protecting Medicare's past payment interests or Medicare's future payment interests.

In one embodiment, the data module 304 receives Medicare information associated with the Medicare beneficiary. In certain embodiments, the one or more tasks for protecting Medicare's payment interests are based on data extracted from the Medicare information. In certain embodiments, the Medicare information may include information related to the Medicare beneficiary, information related to a Medicare claim, or the like. For example, the Medicare information may include a claim notice, an incident report, a Medicare notice, or the like. In certain embodiments, the Medicare information may be uploaded by a user or may be received in hard-copy form and scanned into a system such that the information may be parsed and extracted. Based on the extracted information, the task module 202 may identify one or more tasks for completing a particular process or action associated with the information.

In one embodiment, the interface module 306 presents a graphical interface for protecting Medicare's interests. In one embodiment, the graphical interface displays the progress of one or more tasks, a list of tasks that have been completed and tasks that are remaining, a graphical depiction of the decision tree for the tasks, and/or the like. In some embodiments, the interface module 306 receives user input and data uploaded by a user, including claim documents, reports, notices, beneficiary information, financial information, or the like. The graphical interface presented by the interface module 306 is described in more detail below.

The interface module 306 may provide an interface for presenting and receiving information related to a Medicare incident, such as an incident number, an incident date, and incident status, or the like. The interface module 306 may receive Medicare information related to an incident type from within the interface, such as General Liability services, Workers' Compensation services, and No-Fault services. The interface module 306 may also present incident-specific information, such as the date of the incident, the time of the incident, the nature of the injury, claimant information, financial information, and/or the like.

The interface module 306 may also present an interface for receiving and presenting information related to parties and services. In one embodiment, the parties and services interface presents a plurality of files related to a Medicare beneficiary, which a user can interact with to view information about the files, the parties, and the incident services. In one embodiment, the files presented in the interface may relate to various tasks, such as Medicare beneficiary consent, conditional payment letter requests, conditional payment letter analysis, closure tasks, and/or the like. The parties and services interface may also present the progress of the one or more tasks and subtasks.

The interface module 306 may also present a characteristics interface that displays one or more characteristics related to a Medicare incident. The one or more characteristics presented in the characteristics interface may include characteristics for past, present, and/or future payment interests of Medicare. The one or more characteristics may include communication dates with Medicare and/or its current contractors, amount communicated with Medicare and/or its current contractors, and/or the like. In some embodiments, the one or more characteristics may include communication notes, initial conditional payment letter amount, initial conditional payment letter received date, current conditional payment letter amount, current conditional payment letter received date, maximum conditional payment letter amount, maximum conditional payment letter, and amount received date. Other characteristics may include final demand letters (FDL), case closure letters (CCL), and/or the like.

In a further embodiment, the interface module 306 presents an activity interface that presents activity history for an incident. The activity history may include descriptions related to templates assigned to task handlers or a registered nurse, consent requested, consent received, conditional payment letter requested, conditional payment letter received, evaluating conditional payment letters, conditional payment letter reviewed, as well as dates and task handlers associated with each particular description. The interface module 306 may receive input from a task handler regarding modifying, adding, or deleting descriptions. As documents are received, the interface module 306 provides features on the activity interface that may help a task handler form a rebuttal packet related to the above listed items.

The interface module 306 may present an attachment interface that presents documents, files, or the like related to a Medicare claim. For example, the attachment interface may present copies of consent to release forms signed by the Medicare beneficiaries that are required to obtain conditional payment information from Medicare, copies of conditional payment letters from Medicare that detail the conditional payment information and the amount owed to Medicare, copies of correspondence between the parties, copies of medical records or other claim-related documents relating to the subject incident or injury, copies of settlement, claim closure documents, and/or the like. In certain embodiments, the interface module 306 presents a gateway for sharing documents between different claims, different beneficiaries, or the like via the attachment interface or a different interface of the system.

The interface module 306, in some embodiments, may present an information interface that displays metadata related to the Medicare information, such as the reference number and dates of the incident as well as the date of when the record/claim was created, closed, or last modified. The information interface may also include the identity of the user who created the record, the user who last modified the record, and the user who is currently handling the claim.

In one embodiment, the notification module 308 generates one or more messages, warnings, notifications, or the like. In certain embodiments, the interface module 306 presents information generated by the notification module 308 in an interface on a graphical display. The information generated by the notification module 308 may be related to the one or more tasks, such as a reminder that a deadline is approaching, a status update, and/or the like. The notification module 308, in some embodiments, sends messages to various users, including task handlers and Medicare beneficiaries, via electronic communications, such as email, text message, voice message, social media, and/or the like.

In one embodiment, the report module 310 generates an evaluation report that presents information regarding protecting past, present, and/or future interests of Medicare based on the completion order of the tasks in order to guide a user's decision-making regarding protecting Medicare's payment interests. The evaluation report may consider various laws, regulations, Medicare manuals, Medicare memos, Medicare user guides, and court decisions, as well as other factors affecting Medicare payments. The evaluation report may further comprise strategic-based logic using weak and strong classifiers related to U.S. laws, Medicare manuals, Medicare memos, Medicare user guides, and court decisions. For example, such strategic-based logic may assign values to tasks and pending tasks to compile various classifiers that are used to suggest various strategies or options for protecting the past and present payment interest of Medicare. Depending on multiple factors relative to one another, the evaluation report may suggest various tasks to protect the past and present payment interest of Medicare. The evaluation report may incorporate various aspects regarding the ranking of assigned tasks, completed tasks, higher priority tasks, special instructions, notes, and timelines, as well as other information including formal and snapshot reports outlining future steps and forecasts.

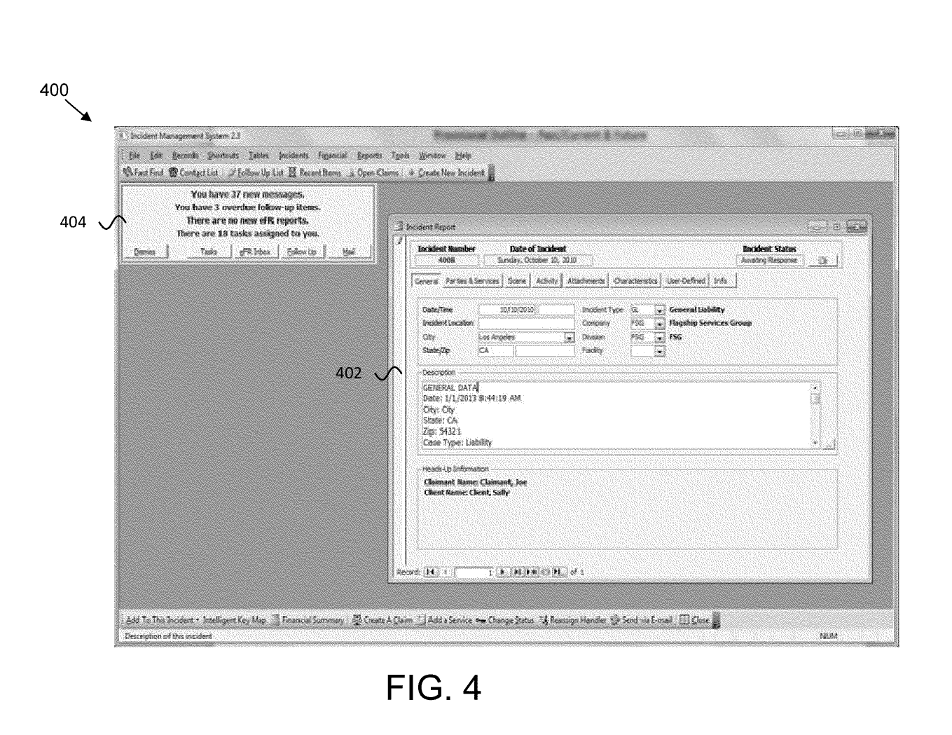

FIG. 4 depicts one embodiment of an interface 400 presented by the interface module 306 for protecting Medicare's payment interests. In one embodiment, the interface module 306 presents an interface 402 that displays information related to a Medicare incident, a Medicare claim, a Medicare beneficiary, or the like, as described above with reference to FIG. 3. The interface 402 may include the various interfaces described above, such as a Medicare incident interface, a parties and services interface, a characteristics interface, an activity interface, an attachment interface, and/or the like. The interface 402 may also present the evaluation report generated by the report module 310 and other documents related to the payment interest being protected. The interface 400 also includes a notification interface 404 that presents messages, warnings, status updates, or the like regarding the status of one or more tasks related to the Medicate payment interest being protected.

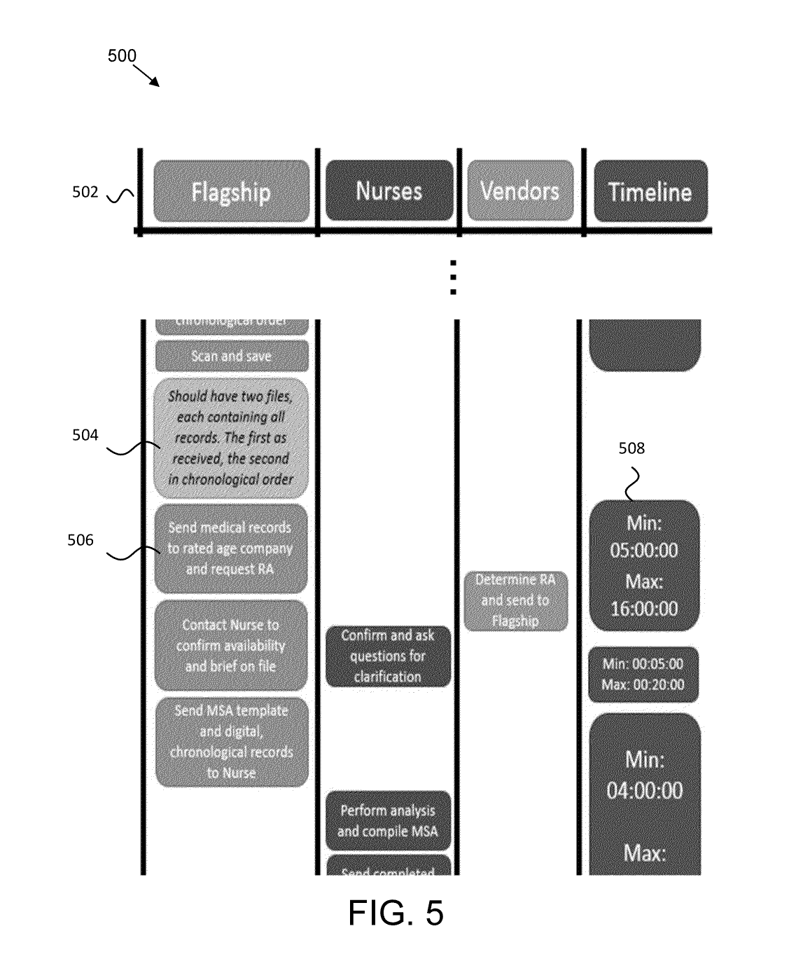

FIG. 5 depicts one embodiment of a portion of a decision tree (or process flow chart) 500 based on the completion order determined by the order module 204. In certain embodiments, the decision tree 500 includes one or more task handlers 502, in this case, various groups that may be assigned by the task assignment module 302 to complete a task. The decision tree 500 also includes one or more tasks 506 that are presented in order of completion, based on their assigned priority values, such that some tasks may be completed concurrently and other tasks must be completed before a subsequent task may be performed. The tasks may be grouped, in order, by the task handlers assigned to the tasks.

The decision tree 500 also includes expected output 504 from a previous task. For example, the expected output may include two files of all the records, one in chronological order and the other in a received order. Thus, if the two files are not received as expected 504, then the adjustment module 206 may adjust the decision tree 500, including deadlines, priority values, or the like. The decision tree 500 may include an expected timeline 508 for one or more tasks in order to determine the total expected time for the entire process related to protecting a Medicare payment interest.

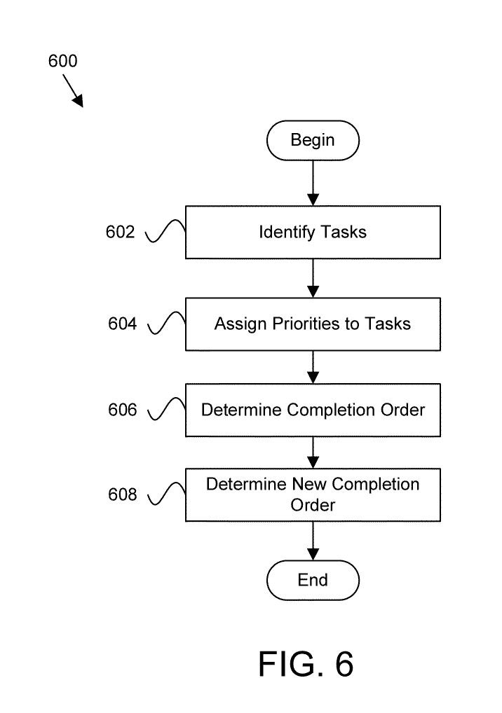

FIG. 6 depicts one embodiment of a schematic flow chart diagram illustrating one embodiment of a method 600 for protecting a Medicare payment interest. In one embodiment, the method 600 begins and a task module 202 identifies 602 one or more tasks associated with protecting a Medicare payment interest for a claim involving a Medicare beneficiary. In certain embodiments, the one or more tasks comprise a decision tree associated with the Medicare payment interest being protected.

In one embodiment, an order module 204 assigns 604 a priority value to each of the one or more tasks. In certain embodiments, the priority value indicates a priority of completing a task relative to one or more different tasks. In certain embodiments, the order module 204 determines 606 a completion order for the one or more tasks based on the priority values. In a further embodiment, an adjustment module 206 determines 608 a new completion order for one or more remaining tasks in response to receiving a status update during completion of the one or more tasks. In certain embodiments, new priority values are assigned to the one or more remaining tasks based on the status update, and the method 600 ends.

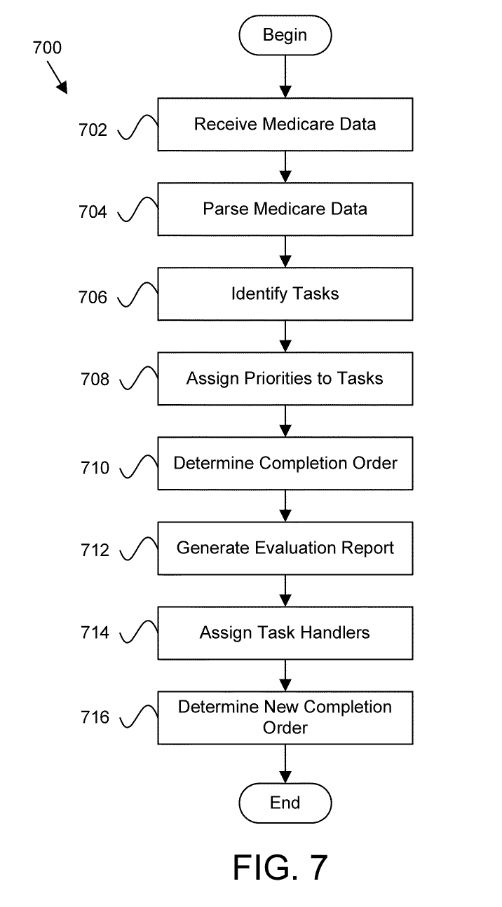

FIG. 7 depicts one embodiment of a schematic flow chart diagram illustrating another embodiment of a method 700 for protecting a Medicare payment interest. In one embodiment, the method 700 begins and a data module 304 receives 702 Medicare data associated with a Medicare beneficiary, such as claim data, incident data, personal data, or the like. In some embodiments, the data module 304 parses 704 information from the Medicare data in order to determine a payment interest associated with the Medicare data, e.g., a past, present, or future interest.

A task module 202 identifies 706 one or more tasks associated with the determined Medicare payment interest. The task module 202 determines the one or more tasks based on the data parsed from the Medicare information. In certain embodiments, the identified tasks, when completed, protect the payment interest of Medicare and may ensure that the insurance carrier, self-insured entity, government entity, attorney, and/or Medicare beneficiary are in compliance with the Medicare regulations, policies, procedures, or the like. In some embodiments, the order module 204 assigns 708 priority values to the one or more tasks and determines 710 a completion order for the one or more tasks based on the priority values.

In a further embodiment, the report module 310 generates 712 an evaluation report based on the completion order of the one or more tasks. The evaluation report presents information regarding the determined order of the identified tasks, suggestions for adjusting the completion order, recommendations for adding or removing various tasks, and/or the like. In certain embodiments, the task assignment module 302 assigns 714 task handlers to one or more identified tasks. In certain embodiments, the task assignment module 302 assigns particular tasks to task handlers who are Medicare processing specialists that are specially trained to perform the particular tasks. In some embodiments, the adjustment module 206 determines a new completion order in response to receiving a status update associated with the Medicare payment interest being protected, and the method 700 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a task module that identifies one or more tasks associated with protecting a Medicare payment interest for a claim involving a Medicare beneficiary, the one or more tasks comprising a decision tree associated with the Medicare payment interest being protected;
an order module that assigns a priority value to each of the one or more tasks and determines a completion order for the one or more tasks based on the priority values, wherein a priority value indicates a priority of completing a task relative to one or more different tasks; and
an adjustment module that determines a new completion order for one or more remaining tasks in response to receiving a status update during completion of the one or more tasks, wherein new priority values are assigned to the one or more remaining tasks based on the status update.

2. The apparatus of claim 1, further comprising a task assignment module that assigns the one or more tasks to one or more task handlers based on the completion order.

3. The apparatus of claim 2, wherein a task handler of the one or more task handlers comprises a Medicare processing specialist who is specialized to perform a particular task of the one or more tasks.

4. The apparatus of claim 1, further comprising a data module that receives Medicare information associated with the Medicare beneficiary, wherein the one or more tasks for protecting the Medicare payment interest are based on data extracted from the Medicare information.

5. The apparatus of claim 1, wherein the status update comprises receiving new Medicare information associated with the Medicare beneficiary, the new Medicare information comprising one or more of Medicare claim information, Medicare regulation information, and Medicare beneficiary information.

6. The apparatus of claim 5, wherein one or more remaining tasks are skipped in response to the new Medicare information.

7. The apparatus of claim 5, wherein a completion deadline of a task of the one or more tasks is accelerated in response to the new Medicare information.

8. The apparatus of claim 1, wherein the order module assigns a priority value to each task of the one or more tasks based on a claim status of a Medicare claim for the Medicare beneficiary, the claim status indicating a current processing state for the Medicare claim.

9. The apparatus of claim 1, wherein the order module assigns a priority value to each task of the one or more tasks based on a compliance status for the claim involving a Medicare beneficiary, the compliance status indicating a compliance risk associated with a Medicare claim involving the Medicare beneficiary.

10. The apparatus of claim 1, wherein the order module assigns a priority value to each task of the one or more tasks based on a financial status for the claim involving a Medicare beneficiary, the financial status indicating a financial risk associated with a Medicare claim involving the Medicare beneficiary.

11. The apparatus of claim 1, wherein the order module assigns a priority value to each task of the one or more tasks based on one or more of task dependency, task timing, and task duration.

12. The apparatus of claim 1, wherein the Medicare interest being protected comprises one of a past interest, a present interest, and a future interest.

13. A method comprising:
identifying one or more tasks associated with protecting a Medicare payment interest for a claim involving a Medicare beneficiary, the one or more tasks comprising a decision tree associated with the Medicare payment interest being protected;
assigning a priority value to each of the one or more tasks and determining a completion order for the one or more tasks based on the priority values, wherein a priority value indicates a priority of completing a task relative to one or more different tasks; and
determining a new completion order for one or more remaining tasks in response to receiving a status update during completion of the one or more tasks, wherein new priority values are assigned to the one or more remaining tasks based on the status update.

14. The method of claim 13, further comprising assigning the one or more tasks to one or more task handlers based on the completion order.

15. The method of claim 14, wherein a task handler of the one or more task handlers comprises a Medicare processing specialist who is specialized to perform a particular task of the one or more tasks.

16. The method of claim 13, further comprising receiving Medicare information associated with the Medicare beneficiary, wherein the one or more tasks for protecting the Medicare payment interest are based on data extracted from the Medicare information.

17. The method of claim 13, wherein the status update comprises receiving new Medicare information associated with the Medicare beneficiary, the new Medicare information comprising one or more of Medicare claim information, Medicare regulation information, and Medicare beneficiary information.

18. The method of claim 13, wherein one or more remaining tasks are skipped in response to the new Medicare information, and wherein a completion deadline of a task of the one or more tasks is accelerated in response to the new Medicare information.

19. The method of claim 13, wherein the Medicare interest being protected comprises one of a past interest, a present interest, and a future interest.

20. A computer program product comprising a computer readable storage medium having program code embodied therein, the program code readable/executable by a processor for:
identifying one or more tasks associated with protecting a Medicare payment interest for a claim involving a Medicare beneficiary, the one or more tasks comprising a decision tree associated with the Medicare payment interest being protected;
assigning a priority value to each of the one or more tasks and determining a completion order for the one or more tasks based on the priority values, wherein a priority value indicates a priority of completing a task relative to one or more different tasks; and
determining a new completion order for one or more remaining tasks in response to receiving a status update during completion of the one or more tasks, wherein new priority values are assigned to the one or more remaining tasks based on the status update.
